(19) United States
(12) Patent Application Publication
(10) Pub. No.: US 2026/0350034 A1
(43) Pub. Date: Nov. 5, 2026

(54) METHOD OF AUTOMATED CREATION OF GRAPHQL AND API SERVER FOR A OPC UA DERIVED RDF GRAPH

(71) Applicant: Siemens Aktiengesellschaft, Munich (DE)

(72) Inventors: Md Ridwan Iqbal, Plainsboro, NJ (US); Julian Mauricio Angel Fernandez, Wien (AT); Roland Eckl, Forchheim (DE); Phani Ram Kumar Kuruganty, Robbinsville, NJ (US)

(73) Assignee: Siemens Aktiengesellschaft, Munich (DE)

(21) Appl. No.: 19/101,721

(22) PCT Filed: Aug. 16, 2022
(86) PCT No.: PCT/US2022/074989

§ 371 Date: Feb. 6, 2025

(51) Int. Cl. G06F 16/25; G06F 16/21; G06F 16/2452; G06F 16/901

(52) U.S. Cl. CPC G06F 16/258; G06F 16/211; G06F 16/2452; G06F 16/9027

(57) ABSTRACT

A computer implemented method for extracting information from an OPC UA specification represented in a RDF knowledge graph includes presenting a query compliant with a GraphQL API in a GraphQL server, receiving the GraphQL query; in the GraphQL server, converting the GraphQL query to a query compliant with SPARQL, extracting information from the RDF knowledge graph using the SPARQL query, and formatting the result of the SPARQL query in a format desired by the user. Additionally in some embodiments, the GraphQL server comprises a GraphQL schema containing information identifying objects and relationships between objects, the GraphQL schema representative of the OPC UA specification; and a GraphQL resolver for receiving a GraphQL query and extracting requested information from the RDF knowledge graph. According to an embodiment, the format desired by the user is javascript object notation (JSON).

### TECHNICAL FIELD

This application relates to industrial systems. More particularly, this application relates to interoperability of different components of an industrial system.

### BACKGROUND

Open Platform Communications, Unified Architecture (OPC UA) defines industry standard models often referred to as companion specifications as they typically address a specific industry problem. These specifications together with the basic OPC UA infrastructure allows exchange of information between industry models thereby allowing interoperability at a semantic level for entities on a shop floor as well as information technology (IT) systems in the factory.

However, searching for information in these models is difficult for conventional IT systems. Prior work has developed methods for utilizing Resource Description Framework (RDF) knowledge graphs to represent OPC UA specifications in a way which can be queried and searched. RDF typically uses SPARQL as a means to query the RDF database. RDF provides the closest means for preserving, storing, and presenting the semantic information relating to OPC UA relationships and hierarchies between process objects in industrial automation scenarios.

The OPC UA standard is a cross-platform, open-source IEC62541 standard for data exchange between devices in industrial systems. OPC UA provides standard interfaces and semantics that enable Interoperability among products from different suppliers in factories. However, the information represented in the OPC UA architecture is difficult to query and search for other uses. One technique for providing queries to OPC UA is to convert the OPC UA ontology into an RDF knowledge graph. However, developing applications to access the OPC UA inspired RDF graph databases is time consuming and requires expert knowledge in SPARQL, the default query language for RDF and semantics web. Additionally, SPARQL allows access to the entire RDF datastore and therefore provides poor security with respect to the overall system.

Other methods for acquiring and utilizing semantic information from an OPC UA architecture are desired.

### SUMMARY

According to aspects of one embodiment of this disclosure, a computer implemented method for extracting information from an OPC UA specification represented in a RDF knowledge graph includes presenting a query compliant with a GraphQL API in a GraphQL server, receiving the GraphQL query; in the GraphQL server, converting the GraphQL query to a query compliant with SPARQL, extracting information from the RDF knowledge graph using the SPARQL query, and formatting the result of the SPARQL query in a format desired by the user. Additionally in some embodiments, the GraphQL server comprises a GraphQL schema containing information identifying objects and relationships between objects, the GraphQL schema representative of the OPC UA specification; and a GraphQL resolver for receiving a GraphQL query and extracting requested information from the RDF knowledge graph. According to an embodiment, the format desired by the user is javascript object notation (JSON).

The GraphQL schema may be configured in a hierarchical tree format similar to the hierarchical structure used in OPC UA and RDF.

Upon receiving a GraphQL compliant query, the GraphQL server recursively traverses the GraphQL hierarchical tree to identify objects specified in the GraphQL query and any sub-objects in the hierarchical tree. Then based on the recursive traversal of the hierarchical tree, a SPARQL compliant query is constructed to extract information related to the objects identified objects in the GraphQL hierarchical tree. The GraphQL server stores a GraphQL type for each OPC UA object class in the OPC UA specification. and each sub-member of an OPC UA object class is specified as a GraphQL type in the GraphQL server.

According to some embodiments of this disclosure, a computer implemented method of extracting information from an OPC UA specification represented in a RDF knowledge graph, comprising: in a semantic introspection and GraphQL schema generator, automatically generating a GraphQL compliant schema and metadata from the RDF knowledge graph, and presenting a GraphQL query to a generic GraphQL server, the generic GraphQL server formatting the GraphQL query to extract information from the RDF knowledge base and return a result of the GraphQL query to a user in a desired format. Automatically generating a GraphQL compliant schema and metadata from the RDF knowledge graph further includes receiving at the semantic introspection and GraphQL schema generator, an endpoint or file containing the RDF knowledge graph and a root node that identifies a starting point in the RDF knowledge graph, recursively traversing the RDF knowledge graph to identify objects in the RDF knowledge graph and relationships between objects in the RDF knowledge graph for each identified object in the RDF knowledge graph, creating a list containing each GraphQL type corresponding to each RDF object, and creating custom metadata containing information that characterizes the organization of the list of GraphQL types.

The generic GraphQL server may perform the steps of: receiving the GraphQL query from the user, accessing the GraphQL schema and metadata, creating a SPARQL query based on the GraphQL schema and metadata; applying the SPARQL query to the RDF knowledge graph, extracting information from the RDF knowledge graph as a result from the SPARQL query, and processing the result of the SPARQL query to create a properly formatted response to the user. A properly formatted response to the user may be formatted ins a GraphQL compliant (JSON) format.

According to embodiments, when creating the SPARQL query the GraphQL server may recursively traverse the hierarchical tree structure of the GraphQL schema to identify GraphQL types relating the query from the user, the consult the metadata to identify relationships between the identified GraphQL types in order to construct the SPARQL query to request information stored in the RDF knowledge graph based on the identified GraphQL types and the relationships between the GraphQL types.

Accordingly to other embodiments of this disclosure, a computer implemented system for retrieving information from an open platform communications unified architecture (OPC UA) specification represented in a resource description format (RDF) knowledge graph is provided that may include a computer processor in communication with a non-transitory memory, where the memory stores computer executable instructions that when executed by the computer processor cause the computer processor to execute a GraphQL schema generator to recursively traverse the RDF knowledge graph in order to create a list of GraphQL types based on RDF object classes identified in the RDF knowledge graph and additionally create metadata describing relationships between GraphQL types contained in the created list. The list and metadata may be stored in the non-transitory memory as a GraphQL schema representative of the OPC UA specification. The non-transitory memory may further include instructions that when executed by the computer processor cause the computer processor to establish a generic GraphQL server, which may receive a GraphQL query from a user and responsive to the GraphQL query, call a GraphQL resolver core to access the GraphQL schema and generate a SPARQL query based on the GraphQL schema. The result of the SPARQL query is processed into a GraphQL compliant response to the user's query.

According to some embodiments, the GraphQL schema generator includes a data representation module that identifies an object in the RDF knowledge graph; generates a SPARQL query based on the identified object; applies the SPARQL query to the RDF knowledge base; receives a result of the SPARQL query. Then the data representation module identifies if any additional objects are identified in the SPARQL query result. if so, additional SPARQL queries are generated for the additional objects otherwise, post-processing of the SPARQL query result is performed to create a standard format used by the data representation module.

According to some embodiments, the GraphQL schema generator further includes a data generation module that processes information created in the data representation module to create a list of GraphQL types corresponding to each object identified in the RDF knowledge base and create metadata containing information describing relationships between the GraphQL types contained in the list. Additionally, the generic GraphQL server further includes GraphQL API service for receiving a GraphQL query from the user and calling a GraphQL resolver core in response to receiving the query. A tree explorer module in the generic GraphQL server receives a request from the GraphQL resolver core and recursively traverse a hierarchical tree embodied in the metadata and provides information relating to the relationships of objects in the RDF knowledge base to the GraphQL resolver core for generating the SPARQL query.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1. is a block diagram of an architecture for providing an API for accessing data from an OPC UA schema according to aspects of embodiments of this disclosure.

FIG. 2 is a block diagram of a Schema generator according to aspects of embodiments of this disclosure.

FIG. 3 is a block diagram of a generic API server according to aspects of embodiments of this disclosure.

FIG. 4 is a process flow diagram for recursive exploration of an OPC UA ontology according to aspects of embodiments of this disclosure.

FIG. 5 is a process flow diagram for generating an API schema from an OPC_UA derived RDF graph according to aspects of embodiments of this disclosure.

FIG. 6. is a block diagram of a computer system that may be used to perform methods and embody systems for accessing information from an OPC UA derived RDF knowledge graph according to embodiments of this disclosure.

FIG. 7 is a process flow diagram for extracting information from an OPC UA derived RDF knowledge graph according to aspects of embodiments of this disclosure.

### DETAILED DESCRIPTION

Embodiments described hereinbelow illustrate the process of automatic inspection of a OPC UA derived RDF ontology and providing useful OPC UA semantic knowledge as a GraphQL API having a generic GraphQL server for serving several types of auto-generated APIs.

OPC UA is an open standard protocol for communication between various machines. Allowing OPC UA data to be converted to RDF provides an especially useful approach allowing semantic extraction of information. However, data converted into RDF data may not be easily consumed by developers without their possession of a strong knowledge of RDF. Described embodiments will automatically crawl an OPC UA derived RDF ontology to find semantic mappings useful to the user. These mappings will expose semantic information describing how various machines and their parts interact with each other.

In a first aspect of embodiments presented in this specification, certain challenges relating to the extraction of data contained in and RDF datastore derived from OPC UA data will be addressed. For example, SPARQL is not a preferred API for IT applications and requires specialized and skilled expert knowledge of SPARQL for query, search, and aggregations tasks. These skills are relatively rare in the industrial automation community. This limits the utility of OPC UA inspired RDF knowledge graphs. Further, providing a direct SPARQL query interface poses a security risk. SPARQL is a powerful interface that allows engineers complete access across the entire RDF database. It therefore opens a door for writing malicious code queries that may degrade system performance or cause destruction or erasure of valuable data.

Presently, there are specifically developed applications and libraries that provide access to data from OPC UA. However, these solutions are application specific and do not provide semantic query and aggregation capabilities. Embodiments of this disclosure recognize that GraphQL is a popular approach for providing web-based APIs. GraphQL has the advantages of an object-oriented API providing more flexibility than other techniques such as REST APIs. While there are some open-source applications that seek to expose OPC UA with a GraphQL-like interface, these applications do not provide advanced semantic and aggregation capabilities that a graph query language such as SPARQL provides. As discussed previously, converting and OPC UA data store to an RDF graph and providing direct access via SPARQL makes such a graph database difficult and costly to use by process and factory automation engineers.

In one embodiment of this disclosure, a system is provided that provides a GraphQL API server based on OPC UA semantic knowledge. The GraphQL API is configured to provide querying facilities to the OPC UA entities that possess a hierarchical tree-like relationship. The GraphQL API further provides advanced semantic query capabilities, which may search based on sibling relationships and also aggregate values based on various search criteria. These advanced capabilities leverage the advantages provided by using RDF knowledge graphs as the underlying data structure for OPC UA information. Without requiring expert knowledge of RDF and its companion query language SPARQL, methods according to embodiments of this disclosure automatically crawl the OPC UA-inspired RDF ontology and find information relating to semantic mappings that expose semantic information describing interactions between various machines or entities and their sub-parts.

A first step in developing a GraphQL API service for OPC UA inspired RDF database is to explore a particular OPC UA companion specification. For example, the companion specification may be the specification for “Robotics”. The companion specification will describe how OPC UA compliant robots are comprised of various sub-parts including motors, gears, axes, and the like. The relationships between the various OPC UA entities are converted to an RDF graph database by tools known in the art. The resulting RDF triples will be representative and contain information about the relationships between the OPC UA entities. Experts versed in OPC UA and RDF may analyze the companion specification and corresponding RDF graph to develop a useful GraphQL schema that provides access to the hierarchical data in an object-oriented manner. The design of the schema should take into consideration the utility of each entity and choose entities having the most utility for providing data that is germane to the operation and support of industrial systems. Information with limited utility, such as entities that would not likely be the object of a query may be omitted from the schema to create a useful and curated API.

The GraphQL schema is created such that each of the original OPC UA classes become a new GraphQL type. For example, a machine or controller becomes a GraphQL data type with its associated properties and sub-members. The sub-members further become GraphQL types or objects until the end of the hierarchy tree is reached. Once the tree is traversed and the GraphQL types are created, the remaining values in the tree will be primitive object types such as strings, floats, integers, and numeric values.

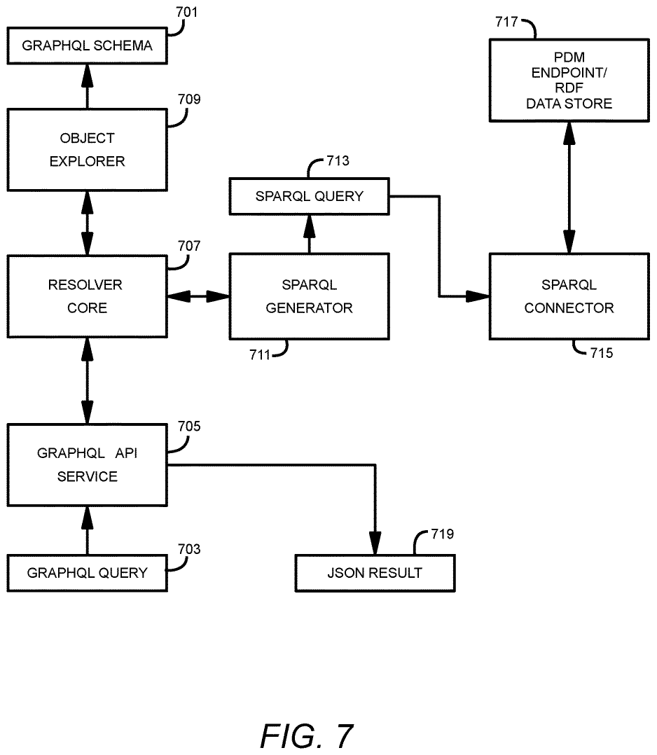

FIG. 7 illustrates an API server that includes several components working in a recursive loop allowing generic handling of GraphQL requests 703 from a user. The server begins with the GraphQL schema 701 described above. Upon receipt of the GraphQL query 703, The server's GraphQL API service 705 receives the request and presents the request to the resolver core 707. The resolver core contains classes where each GraphQL type is represented by a class in the resolver code. Each class includes a members list containing any sub-members associated with the class. For example, a robot class would include sub-members including controllers and powertrains. During a request from a user in the form of a GraphQL query 703, the resolver core is called which employs an object explorer 709, which recursively explores the classes in the GraphQL schema 701 starting from a root node and seeks the information in the class that indicates which information to retrieve from the next sub-member and how the parent-child members are related. This information is returned to the resolver core 707.

During the recursive processing, the API resolver core 707 calls a SPARQL generator 711. The SPARQL generator 711 creates a query in SPARQL 713, which can be presented to the RDF data 717 that reflects the OPC UA specification via a SPARQL connector 715. The SPARQL query 713 pulls semantic information from the RDF triple store. 717 This process is repeated for each GraphQL type. When each GraphQL type has been processed, the GraphQL API service 705 processes the final result to comply with a properly formatted javascript object notation (JSON) file 719, which is provided to the user.

GraphQL is a well-known open-source data query and manipulation language for APIs that may be used to fetch the Semantic rich information from the OPC UA knowledge graph via SPARQL resolvers. However, this requires manual API design. Creating manually written GraphQL APIs and servers with associated GraphQL resolvers requires significant development resources. An engineer with deep knowledge of SPARQL, OPC UA and GraphQL must utilize all three technologies to create a GraphQL API derived from OPC UA ontology. This API design and development is a time consuming and a costly process requiring highly skilled engineers. Furthermore, the resultant API is limited to a specific OPC UA companion specification it was designed for and is not extensible to other types of machines. For this reason, the generation of the GraphQL schema may be automated along with the design of a generic GraphQL server.

Using a manual approach, engineers developing the GraphQL API must manually study and understand the OPC UA companion specification. Next, they must study the OPC UA derived RDF ontology and introspect how various OPC UA nodes and objects are connected or related to each other. Finally, they must create a custom GraphQL Schema that describes all the possible queries a client can make. This GraphQL Schema must correspond to how the data will be stored in the RDF graph. To utilize the GraphQL schema, the engineers will then have to create a custom GraphQL server and resolvers to handle client requests and write custom SPARQL queries and associated post-processing to retrieve the semantic information.

All the steps required to create the API schema and associated resolvers must be handwritten with extensive analysis by experts. The resultant API is also specific to a single specification. Thus, this approach cannot adapt to an arbitrary specification or a machine without a proper specification.

In embodiments of this disclosure, an exemplary architecture to automatically generating a GraphQL schema and generic GraphQL server from an RDF knowledge base derived from an OPC UA specification is provided. This architecture comprises two parts that may work independently while having a common interface between them. The first component is a GraphQL Schema generator that performs semantic inspection of the RDF data to generate a GraphQL schema. This component inspects the OPC UA derived RDF ontology meta-model and creates a list of GraphQL types or classes. Each GraphQL type represents one type of object such as a machine, or it can also represent an aggregate possessing common properties. The GraphQL schema generator also generates custom meta-data for data retrieval from the generic GraphQL API server described below.

The second component is a generic GraphQL server that utilizes the auto generated GraphQL Schema and associated meta-data to expose an HTTP API. The generic GraphQL server can be queried for useful semantic information about the OPC UA machines connected to the RDF Database without requiring extensive analysis and development by subject matter experts.

Both the Schema generator and the Generic GraphQL Server use a recursive data inquisition and retrieval approach relying on the OPC UA ontology itself being structured as a hierarchical tree with parent child relationships. Typically, the top level or root node of this tree is the main machine such as a robot or a stamping machine and the like. This root node comprises child nodes that represent various sub-components of the machine such as motors, gearboxes, and other components. Those sub-components are then further sub-divided into their associated sub-parts. This hierarchical relationship may be inspected and queried by performing a recursive tree traversal starting from the root node. This approach is leveraged by both the Schema-generator component and the GraphQL server component.

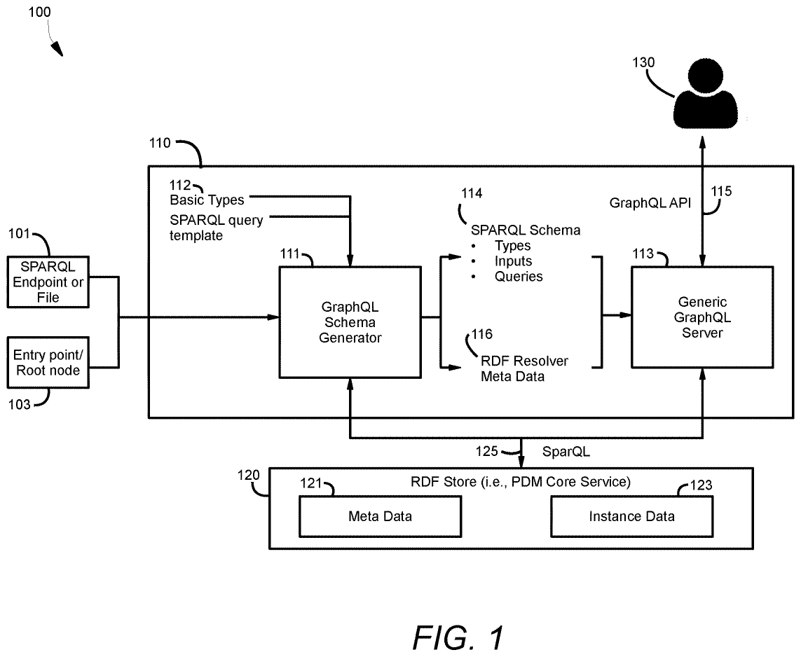

FIG. 1 is a block diagram of an architecture 100 for extracting information from an OPC UA ontology according to embodiments of this disclosure. The architecture 100 receives inputs in the form of an Entry Point or Root Node 103 and an Endpoint or file 101 indicating where the RDF information may be found. The root node reduces the search space and prevents collection of unnecessary information from the schema and associated metadata.

The core 110 of the architecture includes a Schema Generator 111 and a Generic GraphQL server 113 corresponding to the data format of the schema generated by the schema generator 111. The Schema generator 111 and the Generic GraphQL Server 113 use a recursive data exploration and retrieval approach that leverages the nature the OPC UA ontology arranged in a tree-like structure exhibiting parent-child relationships.

The schema generator 111 generates SPARQL queries 125 to examine the RDF Store 120 containing the RDF database metadata 121 and the object or entity information for each component of a system 123. The schema generator 111 collects data about the objects in the RDF store 120 and converts the data into a format that is compatible with the generic API server 113. The data is provided as a SPARQL schema 114 and RDF resolver metadata 116.

The generic API server 113 may receive a request from a user 130 via a user-defined API request 115. The generic API server 113 will receive the API request 115 in a compatible language such as GraphQL. The request 115 is used to allow the generic API server 113 to explore the SPARQL schema 114 and RDF resolver metadata 116. The information from the SPARQL schema 114 and RDF resolver metadata 116 are converted by the generic API server 113 into a format used by the user 130 and provided to the user 130.

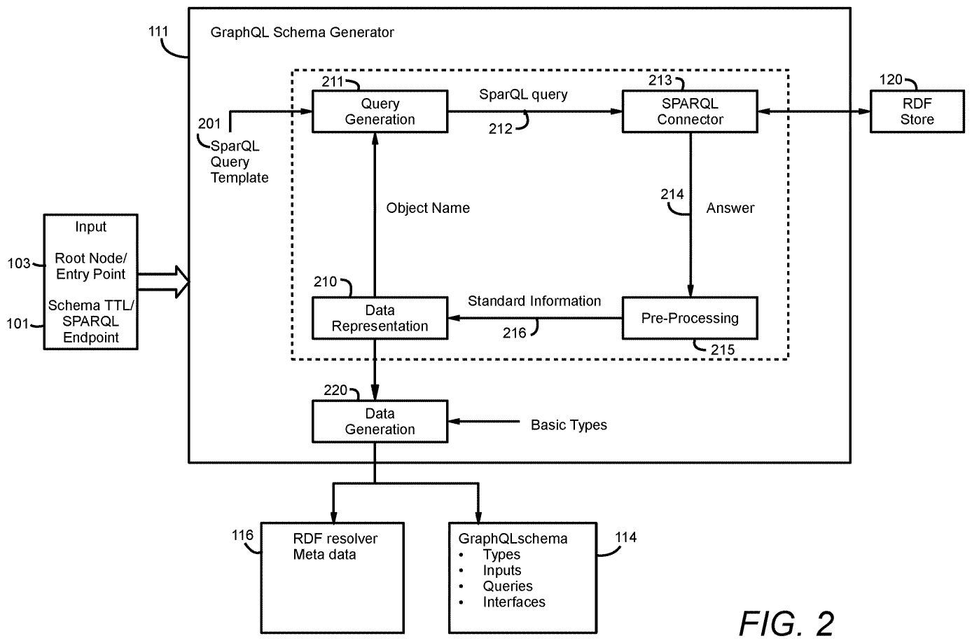

The GraphQL Schema generator 111 is responsible for performing the inspection of a given endpoint/file 101 and to produce all required information 114, 116 to run a GraphQL API server 113 and associated generic GraphQL resolver. Schema generator 111 receives two inputs: a root node 103, which is used to reduce the space search and reduce unnecessary information on the schema and meta-data; and endpoint/file 103, which informs the schema generator 111 where to get the data to do the inspection. The schema generator's 111 components will now be described in greater detail with reference to FIG. 2

FIG. 2 is a block diagram of schema generator 111 shown in FIG. 1. As in FIG. 1, the schema generator 111 receives a root node 103 and endpoint file 101 as inputs. A data representation module 210 includes computer software instructions that enable a computer processor to examine the RDF store 120 to generate a data representation of the semantic objects and relationships in the OPC UA inspired RDF store 120.

The two main components of the GraphQL Schema generator 111 are the data representation module 210 and the data generation module 220. The data representation module 210 performs a recursive introspection of the RDF store at endpoint 101 to identify the data types contained therein. The data representation module 210 creates a representation of the identified data types in an abstract syntax free (ASF) format.

To collect the data, the data representation module 210 calls a SPARQL query containing a particular data type being searched by the data representation module 210. From the root node 103, the data representation module 210 identifies an object type within the RDF store 120 schema. Using a SPARQL query template 201, a SPARQL query is generated in a query generation module 211 that populates the query template 201 with the object type being searched. The generated SPARQL query 212 is processed through a SPARQL connector 213 to access the RDF schema and metadata in the RDF store 120. The response 214 to the query 212 is provided to a pre-processing module 215. The pre-processing module 215 converts the query response 214 into a standard format 216 that is processable by the data representation module 210. The data representation module 210 generates the semantic information from the RDF store 120 into a processable format. In an exemplary embodiment, the data representation module 120 may organize the semantic information into AST format.

When all the object types have been detected and queried, the data collected and stored by the data representation module 210 in the AST format are provided to a data generation module 230. The data generation module 230 converts the data from the data representation module 210 into a GraphQL schema that can be queried by a generic API server and further generates the RDF resolver metadata 116. As part of the query response 214, additional object types may be identified. The additional object types are provided by the data representation module 210 to the query generation module 211 to perform additional queries for each additional object type in the RDF store schema that fall within the tree structure of the root node 103.

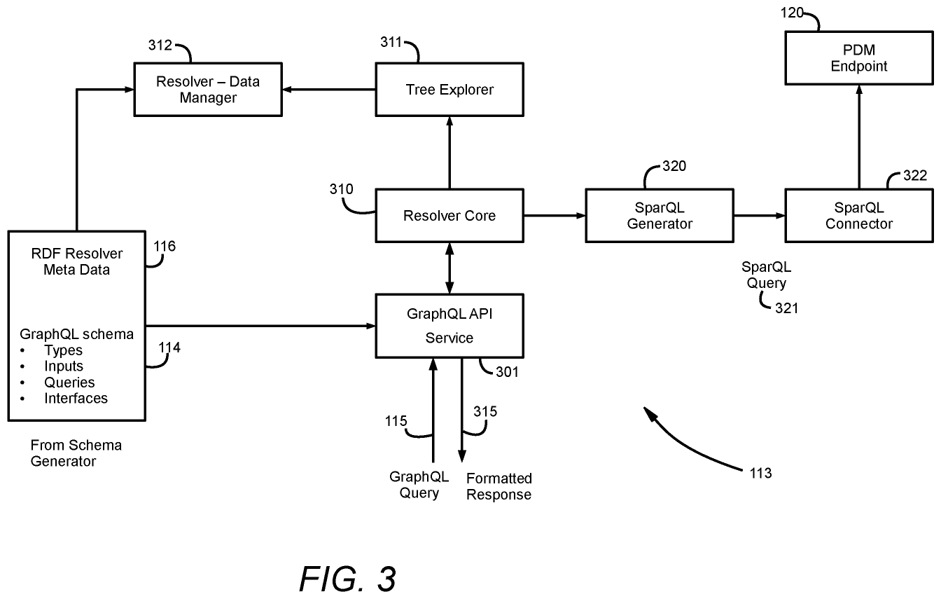

When all object types have been queried and stored by the data generation module 120, the schema data is provided to the data generation module 230. The data generation module 230 converts the data from the data representation module into a GraphQL schema format 114 and associated metadata from the RDF resolver 116. The GraphQL schema 114 and associated metadata 116 may be used by a generic API server (shown in FIG. 3) for accessing semantic information in the OPC UA inspired RDF store 120.

FIG. 3 is a block diagram for a generic API server 113 as shown in FIG. 1. In one embodiment, the API server 113 is configured to receive and process queries from a GraphQL API. The generic API server 113 operates in a recursive loop to generally handle client GraphQL requests 115. In addition to the user request 115, inputs to the generic API server 113 include the GraphQL schema 114 generated from the RDF knowledge base and RDF resolver metadata 116 generated by the schema generator 111 of FIG. 2. In an embodiment, the metadata 116 may be stored in a JSON format. A client request 115 is received by the GraphQL API service 301 which calls the resolver core 310. The resolver core 310 uses a tree explorer component 311 that recursively explores the RDF resolver metadata 116 via the resolver data manager 312. The RDF resolver metadata 116 contains information identifying methods of crawling the OPC UA derived RDF ontology database at the RDF store embodied in a product data management (PDM) endpoint 120. The tree explorer 311 recursively starts from the root node of the meta-data tree 116 and follows the path of the tree based on the client request 115.

While traversing the metadata tree, the resolver-core 310 calls a SPARQL generator 320, which generates a SPARQL query 321 to retrieve the RDF semantic data from the RDF store 120. This process is repeated for all GraphQL nodes having a class type. Finally, the resolver core 310 processes the final result into a properly formatted GraphQL response 315 (e.g., JSON) for the client.

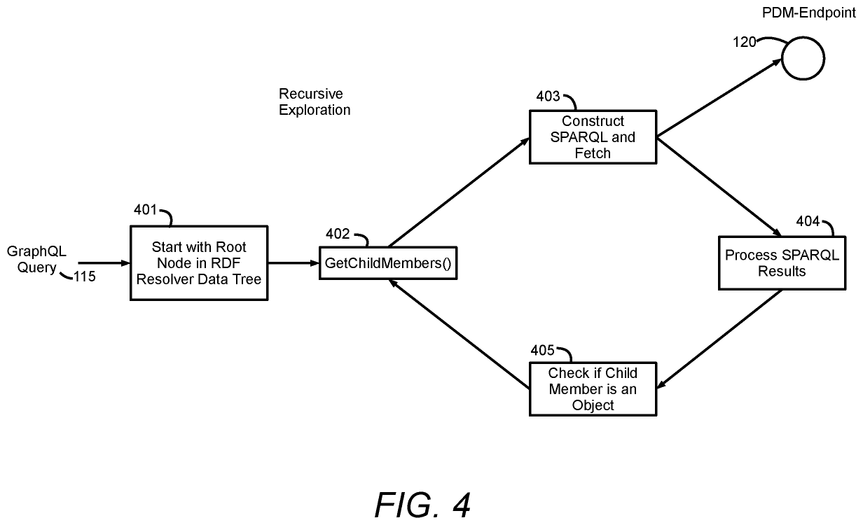

FIG. 4 depicts the recursive introspection of the RDF store 120 using the generic API server according to embodiments of this disclosure. A query is submitted in GraphQL format 115 to the generic API server. The process starts from the root node in the RDF data tree 401. The generic API server looks at the current node and identifies any child nodes 402. Based on the identified types contained in the node of interest, a SPARQL query is generated 403, which can extract the data from the RDF knowledge base at endpoint 120. The data is fetched based on the query and the SPARQL results are processed 404. The data elements retrieved in the SPARQL results are examined to determine if any of the child members represent a data object or type 405. If any of the child nodes are representative of a data object, then the process is called again to determine if the new child node containing a data object contains additional child members 402. The process recursively proceeds until the results no longer produce any child nodes that contain additional data objects.

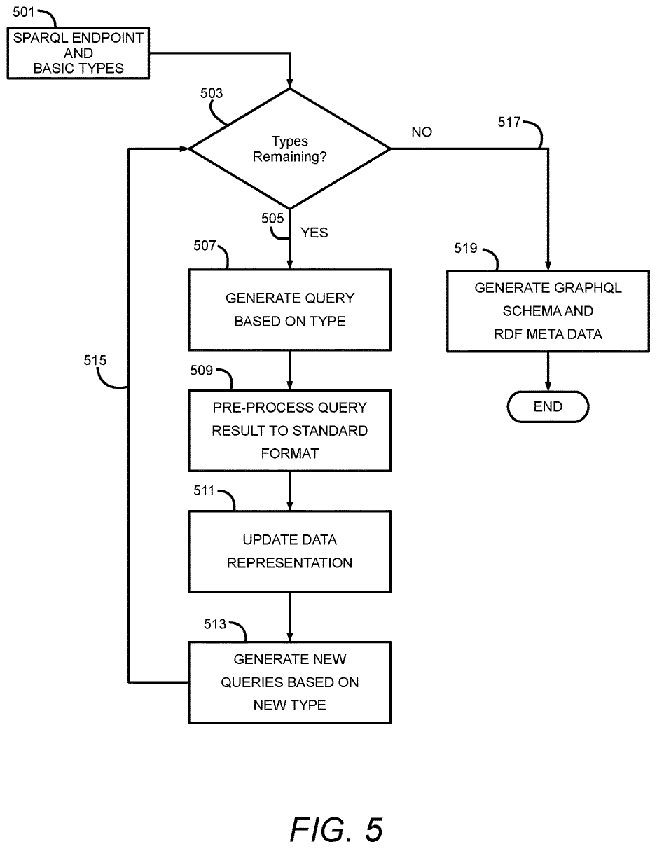

FIG. 5 provides a process flow diagram for generating a GraphQL schema based on an OPC UA specification according to aspects of embodiments of this disclosure. For a UA OPC specification that has been converted to being represented in an RDF knowledge base, the basic object types and an endpoint containing the RDF knowledge based is provided as input 501. The process of generating the schema will continue as long as there are remaining object types to be included in the schema 503. If remaining object types exist 505, a query is generated based on the object type of interest 507. The query will be in a format compatible for retrieving information from the RDF knowledge graph, such as SPARQL. The query is run on the RDF knowledge graph and the result is pre-processed and re-formatted to a standard format 509. According to embodiments, the standard format may be represented as a GraphQL object type or class along with metadata obtained from the RDF knowledge graph. The data representation in the schema is updated using the standardized query result 511.

This invention provides significant advantages over the previous manual GraphQL API design and development by specialized engineers. This schema generation via inspection uses automated intelligence to crawl the OPC UA RDF tree and retrieve all the possible data points available in the ontology. This makes the system generic and flexible. A new machine with a completely new component structure can introspected and the data can be exposed to clients without having to manually study the specifications and ontology structure. The generic GraphQL server is also intelligent, flexible, and able to retrieve OPC UA machine data without manually handwritten SPARQL queries.

The schema generation and generic API server approach also standardizes the API format which makes it easier for consumers of the API to also automate the consumption process, further reducing costs.

The key algorithm causing the advantage is both the recursive inspection of the OPC UA RDF tree and generation of a GraphQL schema and associated meta data, as well as a generic GraphQL server that is flexible enough to automatically create SPARQL queries for data retrieval based on the generated schema.

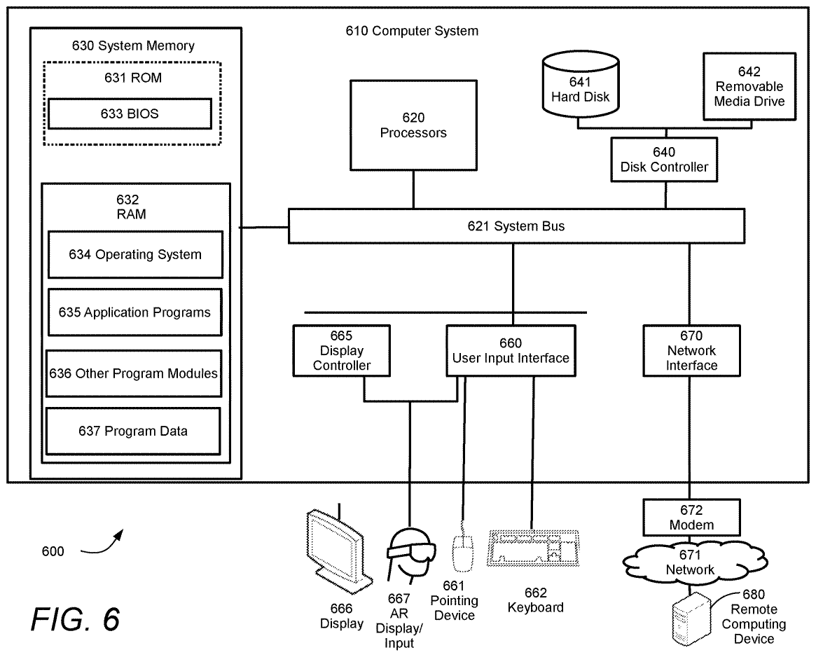

FIG. 6 illustrates an exemplary computing environment 600 within which embodiments of the invention may be implemented. Computers and computing environments, such as computer system 610 and computing environment 600, are known to those of skill in the art and thus are described briefly here.

As shown in FIG. 6, the computer system 610 may include a communication mechanism such as a system bus 621 or other communication mechanism for communicating information within the computer system 610. The computer system 610 further includes one or more processors 620 coupled with the system bus 621 for processing the information.

The processors 620 may include one or more central processing units (CPUs), graphical processing units (GPUs), or any other processor known in the art. More generally, a processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting, or transmitting information for use by an executable procedure or an information device, and/or by routing the information to an output device. A processor may use or comprise the capabilities of a computer, controller, or microprocessor, for example, and be conditioned using executable instructions to perform special purpose functions not performed by a general-purpose computer. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

Continuing with reference to FIG. 6, the computer system 610 also includes a system memory 630 coupled to the system bus 621 for storing information and instructions to be executed by processors 620. The system memory 630 may include computer readable storage media in the form of volatile and/or nonvolatile memory, such as read only memory (ROM) 631 and/or random-access memory (RAM) 632. The RAM 632 may include other dynamic storage device(s) (e.g., dynamic RAM, static RAM, and synchronous DRAM). The ROM 631 may include other static storage device(s) (e.g., programmable ROM, erasable PROM, and electrically erasable PROM). In addition, the system memory 630 may be used for storing temporary variables or other intermediate information during the execution of instructions by the processors 620. A basic input/output system 633 (BIOS) containing the basic routines that help to transfer information between elements within computer system 610, such as during start-up, may be stored in the ROM 631. RAM 632 may contain data and/or program modules that are immediately accessible to and/or presently being operated on by the processors 620. System memory 630 may additionally include, for example, operating system 634, application programs 635, other program modules 636 and program data 637.

The computer system 610 also includes a disk controller 640 coupled to the system bus 621 to control one or more storage devices for storing information and instructions, such as a magnetic hard disk 641 and a removable media drive 642 (e.g., floppy disk drive, compact disc drive, tape drive, and/or solid-state drive). Storage devices may be added to the computer system 610 using an appropriate device interface (e.g., a small computer system interface (SCSI), integrated device electronics (IDE), Universal Serial Bus (USB), or FireWire).

The computer system 610 may also include a display controller 665 coupled to the system bus 621 to control a display or monitor 666, such as a cathode ray tube (CRT) or liquid crystal display (LCD), for displaying information to a computer user. The computer system includes an input interface 660 and one or more input devices, such as a keyboard 662 and a pointing device 661, for interacting with a computer user and providing information to the processors 620. The pointing device 661, for example, may be a mouse, a light pen, a trackball, or a pointing stick for communicating direction information and command selections to the processors 620 and for controlling cursor movement on the display 666. The display 666 may provide a touch screen interface which allows input to supplement or replace the communication of direction information and command selections by the pointing device 661. In some embodiments, an augmented reality device 667 that is wearable by a user, may provide input/output functionality allowing a user to interact with both a physical and virtual world. The augmented reality device 667 is in communication with the display controller 665 and the user input interface 660 allowing a user to interact with virtual items generated in the augmented reality device 667 by the display controller 665. The user may also provide gestures that are detected by the augmented reality device 667 and transmitted to the user input interface 660 as input signals.

The computer system 610 may perform a portion or all of the processing steps of embodiments of the invention in response to the processors 620 executing one or more sequences of one or more instructions contained in a memory, such as the system memory 630. Such instructions may be read into the system memory 630 from another computer readable medium, such as a magnetic hard disk 641 or a removable media drive 642. The magnetic hard disk 641 may contain one or more datastores and data files used by embodiments of the present invention. Datastore contents and data files may be encrypted to improve security. The processors 620 may also be employed in a multi-processing arrangement to execute the one or more sequences of instructions contained in system memory 630. In alternative embodiments, hard-wired circuitry may be used in place of or in combination with software instructions. Thus, embodiments are not limited to any specific combination of hardware circuitry and software.

As stated above, the computer system 610 may include at least one computer readable medium or memory for holding instructions programmed according to embodiments of the invention and for containing data structures, tables, records, or other data described herein. The term “computer readable medium” as used herein refers to any medium that participates in providing instructions to the processors 620 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 641 or removable media drive 642. Non-limiting examples of volatile media include dynamic memory, such as system memory 630. Non-limiting examples of transmission media include coaxial cables, copper wire, and fiber optics, including the wires that make up the system bus 621. Transmission media may also take the form of acoustic or light waves, such as those generated during radio wave and infrared data communications.

The computing environment 600 may further include the computer system 610 operating in a networked environment using logical connections to one or more remote computers, such as remote computing device 680. Remote computing device 680 may be a personal computer (laptop or desktop), a mobile device, a server, a router, a network PC, a peer device, or other common network node, and typically includes many or all of the elements described above relative to computer system 610. When used in a networking environment, computer system 610 may include modem 672 for establishing communications over a network 671, such as the Internet. Modem 672 may be connected to system bus 621 via user network interface 670, or via another appropriate mechanism.

Network 671 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 610 and other computers (e.g., remote computing device 680). The network 671 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite, or any other wireless connection methodology generally known in the art. Additionally, several networks may work alone or in communication with each other to facilitate communication in the network 671.

An executable application, as used herein, comprises code or machine-readable instructions for conditioning the processor to implement predetermined functions, such as those of an operating system, a context data acquisition system or other information processing system, for example, in response to user command or input. An executable procedure is a segment of code or machine-readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers, and processes can be implemented using hardware components, software components, and/or combinations thereof. No claim element herein is to be construed under the provisions of 35 U.S.C. 112, sixth paragraph, unless the element is expressly recited using the phrase “means for.”

What is claimed is:

1. A computer implemented method for extracting information from an Open Platforms Communication United Architecture (OPC UA) specification represented in a resource description format (RDF) knowledge graph, comprising:
presenting a query compliant with a GraphQL API;
in a GraphQL server, receiving the GraphQL query;
in the GraphQL server, converting the GraphQL query to a query compliant with SPARQL;
extracting information from the RDF knowledge graph using the SPARQL query;
formatting the result of the SPARQL query in a format desired by the user.

2. The method of claim 1, the GraphQL server comprising;
a GraphQL schema containing information identifying objects and relationships between objects, the GraphQL schema representative of the OPC UA specification; and
a GraphQL resolver for receiving a GraphQL query and extracting requested information from the RDF knowledge graph.

3. The method of claim 1, wherein the format desired by the user is javascript object notation (JSON).

4. The method of claim 1, wherein the GraphQL schema is configured in a hierarchical tree format.

5. The method of claim 4, further comprising:
in the GraphQL server, upon receiving the GraphQL compliant query:
recursively traversing the GraphQL hierarchical tree to identify objects specified in the GraphQL query and any sub-objects in the hierarchical tree.

6. The method of claim 5, further comprising:
based on the recursive traversal of the hierarchical tree, constructing the SPARQL compliant query to extract information related to the objects identified objects in the GraphQL hierarchical tree.

7. The method of claim 1, wherein the GraphQL server contains a GraphQL type for each OPC UA object class in the OPC UA specification.

8. The method of claim 7, wherein each sub-member of an OPC UA object class is specified as a GraphQL type in the GraphQL server.

9. A computer implemented method of extracting information from an Open Platforms Communications United Architecture (OPC UA) specification represented in a Resource Description Format (RDF) knowledge graph, comprising:
in a semantic introspection and GraphQL schema generator, automatically generating a GraphQL compliant schema and metadata from the RDF knowledge graph; and
presenting a GraphQL query to a generic GraphQL server, the generic GraphQL server formatting the GraphQL query to extract information from the RDF knowledge base and return a result of the GraphQL query to a user in a desired format.

10. The method of claim 9, where automatically generating a GraphQL compliant schema and metadata from the RDF knowledge graph comprises:
receiving at the semantic introspection and GraphQL schema generator, an endpoint or file containing the RDF knowledge graph and a root node that identifies a starting point in the RDF knowledge graph;
recursively traversing the RDF knowledge graph to identify objects in the RDF knowledge graph and relationships between objects in the RDF knowledge graph;
for each identified object in the RDF knowledge graph, creating a list containing each GraphQL type corresponding to each RDF object; and
creating custom metadata containing information that characterizes the organization of the list of GraphQL types.

11. The method of claim 9, wherein the generic GraphQL server performs the steps of:
receiving the GraphQL query from the user;
accessing the GraphQL schema and metadata;
creating a SPARQL query based on the GraphQL schema and metadata;
applying the SPARQL query to the RDF knowledge graph;
extracting information from the RDF knowledge graph as a result from the SPARQL query; and
processing the result of the SPARQL query to create a properly formatted response to the user.

12. The method of claim 11, wherein the properly formatted response to the user is a GraphQL compliant javascript object notation (JSON) format.

13. The method of claim 11, wherein the GraphQL schema is formatted as a hierarchical tree structure.

14. The method of claim 13, wherein creating the SPARQL query comprises:
recursively traversing the hierarchical tree structure of the GraphQL schema to identify GraphQL types relating the query from the user;
consulting the metadata to identify relationships between the identified GraphQL types; and
constructing the SPARQL query to request information stored in the RDF knowledge graph based on the identified GraphQL types and the relationships between the GraphQL types.

15. A computer implemented system for retrieving information from an open platform communications unified architecture (OPC UA) specification represented in a resource description format (RDF) knowledge graph, comprising:
a computer processor in communication with a non-transitory memory, the memory containing computer executable instructions that when executed by the computer processor cause the computer processor to:
in a GraphQL schema generator, recursively traverse the RDF knowledge graph;
create a list of GraphQL types based on RDF object classes identified in the RDF knowledge graph;
create metadata describing relationships between GraphQL types contained in the created list; and
store the list and metadata in the non-transitory memory as a GraphQL schema representative of the OPC UA specification.

16. The system of claim 15, the non-transitory memory further containing instructions that when executed by the computer processor cause the computer processor to:
establish a generic GraphQL server, the GraphQL server configured to:
receive a GraphQL query from a user:
responsive to the receiving of the GraphQL query, call a GraphQL resolver core;
in the GraphQL resolver core, access the GraphQL schema;
in the GraphQL resolver core, generate a SPARQL query based on the GraphQL schema; and
in the GraphQL server, process a result of the SPARQL query into a GraphQL compliant response to the user's query.

17. The system of claim 15, wherein the GraphQL schema generator comprises:
a data representation module, the data representation module configured to:
identify an object in the RDF knowledge graph;
generate a SPARQL query based on the identified object;
apply the SPARQL query to the RDF knowledge base;
receive a result of the SPARQL query;
identify if any additional objects are identified in the SPARQL query result; and
on a condition that additional objects were identified, generate additional SPARQL queries for the additional objects or on condition that no new objects are identified in the SPARQL query results, post-process the SPARQL query result to a standard format used by the data representation module.

18. The system of claim 17, wherein the GraphQL schema generator further comprises:
a data generation module, the data generation module configured to:
process information created in the data representation module to create a list of GraphQL types corresponding to each object identified in the RDF knowledge base; and
create metadata containing information describing relationships between the GraphQL types contained in the list.

19. The system of claim 16, the generic GraphQL server further comprising:
a GraphQL API service for receiving a GraphQL query from the user, and responsive to receiving the GraphQL query, calling a GraphQL resolver core.

20. The system of claim 19, the generic GraphQL server further comprising:
a tree explorer module configured to receive a request from the GraphQL resolver core, recursively traverse a hierarchical tree embodied in the metadata and provide information relating to the relationships of objects in the RDF knowledge base to the GraphQL resolver core for generating the SPARQL query.
